(19) United States
(12) Patent Application Publication
(10) Pub. No.: US 2007/0272284 A1
(43) Pub. Date: Nov. 29, 2007

(54) Dishwasher

(75) Inventor: Soon Yong Kwon, Busan (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/802,194

(22) Filed: May 21, 2007

(30) Foreign Application Priority Data
May 25, 2006 (KR) 10-2006-0047166

(51) Int. Cl. B08B 3/00; B08B 3/04

(52) U.S. Cl. 134/56 D; 134/104.2

(57) ABSTRACT

A dishwasher is provided. The dishwasher includes a tub, a sump, and a sealing member. The tub includes a washing space, and the sump is coupled to a lower portion of the tub. The sealing member is interposed between the tub and the sump, and includes a protrusion contacting one of the tub and the sump to prevent a washing water leakage.

### BACKGROUND OF THE INVENTION

1. Field of the Invention

The present invention relates to a dishwasher, and more particularly, to a dishwasher that improves a structure of a sealing member installed at a coupling portion of a sump coupled to a lower surface of a tub of the dishwasher to prevent washing water from leaking.

2. Description of the Related Art

Generally, the dishwasher is an apparatus for spraying washing water into a tub at high pressure to allow the sprayed washing water to be touched a dish and wash foreign substances such as food leftovers remaining on the surface of the dish.

In detail, the dishwasher includes a tub in which a washing tub is formed, and a sump mounted on the lower surface of the tub, for storing washing water. Also, washing water is moved to a spraying nozzle by a pumping operation of a washing pump mounted inside the sump, and the washing water moved to the spraying nozzle is sprayed at high pressure through a spraying hole formed in the end of the spraying nozzle.

Also, the washing water sprayed at the high pressure collides the surface of a dish to allow foreign substances such as food leftovers remaining on the dish to fall to the bottom of the tub.

A dishwashing cycle includes a washing cycle for washing foreign substances remaining on a dish, a rinsing cycle for rinsing the dish after the washing cycle is completed, and a drying cycle for removing moisture remaining on the surface of the dish after the rinsing cycle is completed.

According to a related art dishwasher, a washing operation is performed inside a tub, and a sump is coupled to a lower outer side of the tub. Also, washing water introduced into the tub is drained through the sump.

However, washing water may leak through a coupling portion between the tub and the sump while the washing water is drained through the sump.

### SUMMARY OF THE INVENTION

Accordingly, the present invention is directed to a dishwasher that substantially obviates one or more problems due to limitations and disadvantages of the related art.

An object of the present invention is to provide a dishwasher that provides a sealing member interposed between a tub and a sump mounted on a lower portion of the tub so that the sump is more strongly and closely attached on the tub to prevent washing water from leaking.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dishwasher including: a tub in which a washing space is formed; a sump coupled to a lower portion of the tub; and a sealing member interposed between the tub and the sump, and including a protrusion contacting one of the tub and sump to prevent a washing water leakage.

In another aspect of the present invention, there is provided a dishwasher including: a sump; a tub including a sleeve extending downward from a bottom of the tub to couple to an inner peripheral surface of the sump; and a sealing member including a plurality of protrusions contacting an inner peripheral surface of the sump and an outer peripheral surface of the sleeve to prevent washing water leakage.

According to a dishwasher of the present invention, since a protrusion formed at a sealing member can seal a gap formed between a tub and a sump to prevent washing water from leaking through the gap.

Also, according to a dishwasher of the present invention, attaching force between a tub and a sump increases, so that vibration or noise that may be generated during a washing cycle can reduce.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic side cross-sectional view of a dishwasher having a sealing member according to the present invention;

FIG. 2 is an exploded perspective view illustrating a tub and a sump coupled to each other according to the present invention;

FIG. 3 is a perspective view of a sealing member according to the present invention; and

FIG. 4 is a cross-sectional view of FIG. 3, taken along a line I-I′; and

FIG. 5 is a cross-sectional view illustrating a tub with a sealing member interposed and a sump coupled to each other according to the present invention.

### DETAILED DESCRIPTION OF THE INVENTION

Reference will now be made in detail to the preferred embodiments of the present invention, examples of which are illustrated in the accompanying drawings.

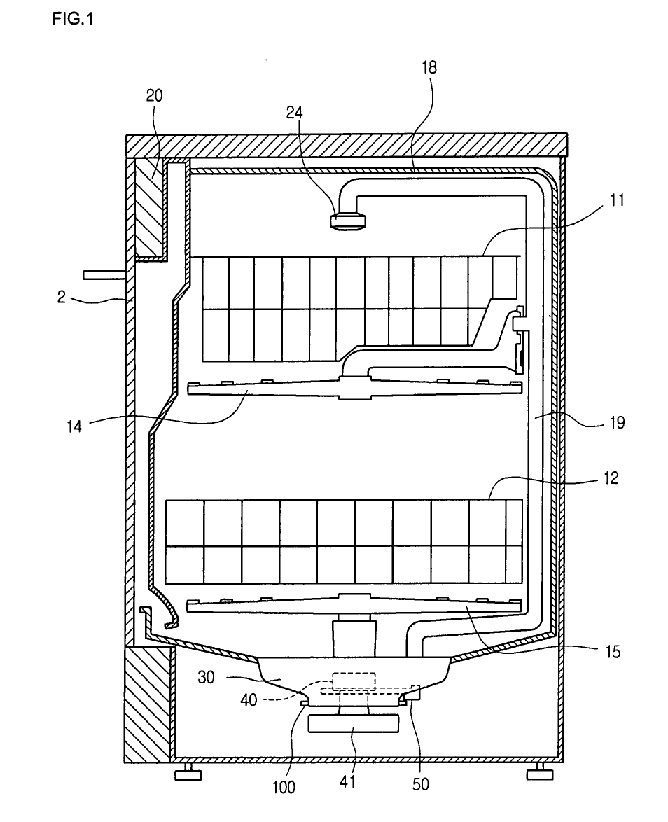

FIG. 1 is a schematic side cross-sectional view of a dishwasher having a sealing member according to the present invention.

Referring to FIG. 1, the dishwasher includes: a tub 18 constituting an appearance and in which a dish washing tub is formed; a door 2 formed on the front side of the tub 18 to open and close the dish washing tub; a display 20 mounted on the upper front portion of the tub and including buttons for controlling various washing cycles; a sump 30 formed in the lower central portion of the tub 18 to store washing water; a sealing member 100 interposed between the tub 18 and the sump 30; and a heater 50 installed inside the sump 30 to heat washing water to high temperature.

Also, the dishwasher includes a washing pump 40 connected to the sump 30 and pumping washing water stored in the sump 30 at high pressure, and a motor 41 attached on the rear side of the washing pump 40 to drive the washing pump 40.

Also, the dishwasher includes a water guide 19 serving as a path through which washing water pumped by the washing pump 40 moves, a lower nozzle 15 provided above the sump 30 and formed in the lower portion of the dish washing tub to spray washing water upward, an upper nozzle 14 attached on the upper portion of the water guide 19, perpendicularly extending from the water guide 19, and located on the central portion of the dish washing tub, and a top nozzle 24 formed at a ceiling of the tub to spray washing water vertically downward.

Also, the dishwasher includes an upper rack 11 mounted above the upper nozzle 14 so that a dish received in the upper rack 11 is washed by the upper nozzle 14, and a lower rack 12 mounted above the lower nozzle 15 so that a dish received in the lower rack 12 is washed by the lower nozzle 15.

An operation of a dishwasher according to the present invention will be described below.

First, the door 2 of the dishwasher is opened by a user, the upper rack 11 and/or lower rack 12 is drawn to the outside of the washing tub. A dish is received in the racks 11 and 12, the door 2 is closed, and power is applied to operate the dishwasher.

Meanwhile, when power is applied to the dishwasher and a washing cycle is performed, washing water delivered from a water supplying source is introduced into the sump 30. Also, after a predetermined amount of washing water is introduced into the sump, the motor 50 operates.

After that, as an impeller (not shown) provided inside the washing pump 40 axially connected to the motor 50 rotates, washing water is alternately pumped to the lower nozzle 15 and the water guide 19.

Also, washing water pumped to the water guide 19 moves to the top nozzle 24 and the upper nozzle 14 and is finally sprayed into the washing tub. Also, dishes received in the racks 11 and 12 are washed by the sprayed washing water.

Here, the top nozzle 24 sprays washing water vertically downward, and the upper nozzle 14 sprays washing water vertically upward to wash a dish received in the upper rack 11.

Also, the lower nozzle 15 sprays washing water vertically upward to wash a dish received in the lower rack 12. Also, spray holes can be formed in the lower surface of the upper nozzle 14 to allow washing water to be sprayed in both an upper direction and a lower direction, so that the upper surface of the dish received in the lower rack 12 is simultaneously washed.

Also, the washing water contained in the tub is introduced to the sump 30 during the washing cycle. Here, the lower surface of the tub and the sump are sealed by the sealing member 100, so that the washing water does not leak. Also, foreign substances contained in used washing water collected at the sump 30 is filtered by a filter (not shown). The foreign substance-filtered washing water is drained to the outside of the dishwasher by a draining pump (not shown).

Also, when the washing water is drained to the outside, clean washing water is introduced again to the sump 30 via an inlet. The clean washing water is sprayed via the spraying nozzles 14 and 15 as in the washing cycle. A heating/rinsing cycle is performed on a dish using the sprayed clean washing water. Also, when the heating/rising cycle is completed, a drying cycle is performed, so that a washing operation is completed.

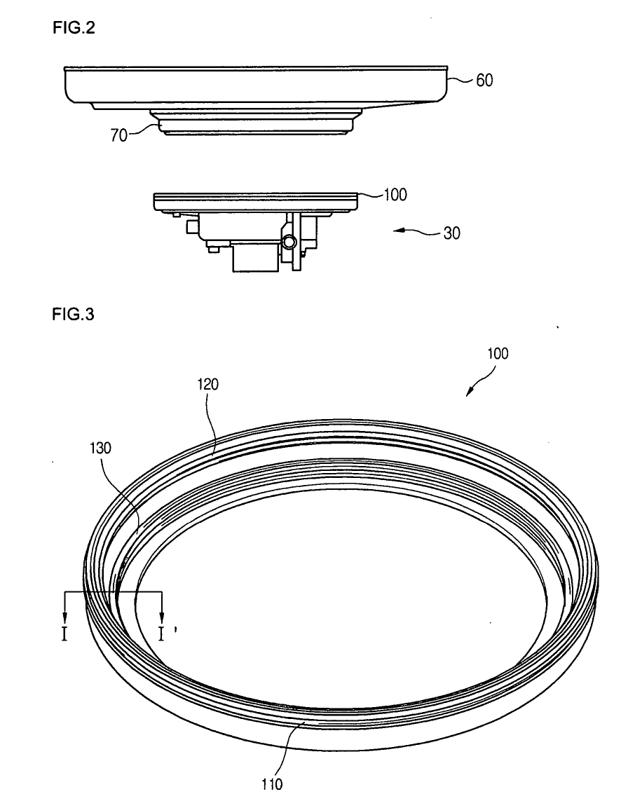

FIG. 2 is an exploded perspective view illustrating a tub and a sump coupled to each other according to the present invention.

Referring to FIG. 2, the dishwasher having a sealing member includes a tub in which a washing tub is formed, a tub base 60 mounted on the lower surface of the tub, a sump 30 coupled to the lower surface of the tub base 60, and the sealing member 100 interposed between the tub base 60 and the sump 30.

In detail, the tub base 60 passes through the lower portion of the tub, which is a washing space. That is, a stain filter is formed on the upper surface of the tub base 60 to primarily filter garbage washing from dishes using washing water in the tub.

Also, a sleeve 70 extends from the lower surface of the tub base 60, and the sump 30 is closely coupled to the sleeve 70.

Here, the sealing member 100 according to the present invention is detachably mounted on the upper edge of the sump 30. Also, the sealing member 100 protrudes a predetermined length from the upper surface of the edge of the sump 30 with consideration of coupling with the sleeve 70 formed on the tub base 60, and couples to the sleeve 70. Therefore, the edge of the sleeve 70 of the tub base 60 is seated on the sealing member 100 coupled to the sump 30, so that more efficient sealing is performed. Also, the shape and coupling figure of the sealing member 100 will be described in more detail with reference to the relevant drawing.

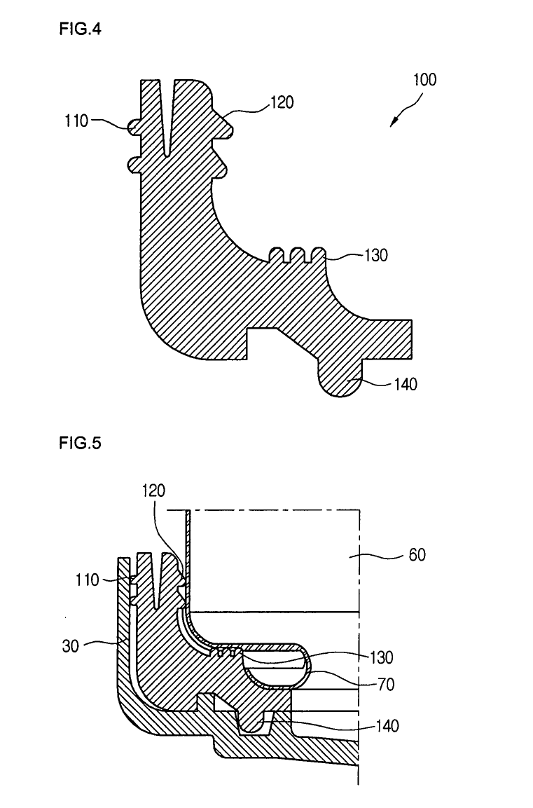

FIG. 3 is a perspective view of a sealing member according to the present invention, FIG. 4 is a cross-sectional view of FIG. 3, taken along a line I-I′, and FIG. 5 is a cross-sectional view illustrating a tub with a sealing member interposed and a sump coupled to each other according to the present invention.

Referring to FIGS. 3 to 5, the sealing member 100 includes at least one outer protrusion 110 formed on the outer side, at least one inner protrusion 120 formed on the inner side, and at least lower protrusion 130 formed on the lower portion.

In detail, the sealing member 100 has an approximately round ring shape on the whole, and is manufactured through injection molding. Also, the sealing member 100 has an about “L”-shaped cross-section. The inner portion of the “L” shape is referred to as an inner side or an inside, and the outer portion of the “L” shape is referred to as an outer side hereinafter.

The sealing member 100 may be formed in a rubber member having predetermined elasticity, but is not limited thereto, and a variety of shapes and materials can be proposed.

Also, two protrusions are banded along the outer side of the sealing member 100 to constitute outer protrusions 110. Also, a lower protrusion 140 protruding downward from the sealing member 100 allows the sump 30 to be more strongly attached in cooperation with the outer protrusions 110.

Also, two inner protrusions 120 are formed on the inner side of the sealing member 100 that is opposite to the outer side of the sealing member 100, to correspond to the outer protrusions 110. That is, the two protrusions 110 and 120 are banded along the inner and outer sides of the sealing member 100.

Also, three lower protrusions 130 protrude upward a predetermined length from the lower inner surface of the sealing member 100 as illustrated in the drawing. Therefore, secondary sealing is made by the inner protrusions 120 and the lower protrusions 130 to prevent a water leakage. Also, the protrusions are not limited to the drawings provided in the present invention, and a plurality of protrusions 110, 120, and 130 can be provided, of course.

In other words, the inner protrusion 110 horizontally extends to the inner side of the sealing member 100. The lower protrusion 130 extends vertically upward from the lower side of the sealing member 100. That is, the inner protrusion 110 and the lower protrusion 130 extend in directions perpendicular to each other.

The inner protrusion 110 and the lower protrusion 130 may extend in directions perpendicular to each other, but are not limited thereto, and a variety of embodiments can be proposed depending on a coupling portion and shape of the tub base 60 and the sump 30, which also fall within the scope of the present invention.

With the above construction, the tub base 60 is seated on the sump 30 to not only prevent a washing water leakage, but also absorb external impact without shaking.

According to a dishwasher of the present invention, a protrusion formed on a sealing member can seal a gap between a tub and a sump to prevent washing water from leaking through the gap.

Also, according to a dishwasher of the present invention, attaching force between the tub and the sump increases, so that vibration or noise generated during a washing cycle can reduce.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher comprising:
a tub in which a washing space is formed;
a sump coupled to a lower portion of the tub; and
a sealing member interposed between the tub and the sump, and including a protrusion contacting one of the tub and the sump to prevent a washing water leakage.

2. The dishwasher according to claim 1, wherein the sealing member comprises protrusions protruding to inner and outer sides of the sealing member to contact both the tub and the sump, respectively.

3. The dishwasher according to claim 1, wherein a plurality of protrusions are banded consecutively along an outer peripheral surface of the sealing member.

4. The dishwasher according to claim 1, wherein a plurality of protrusions are banded consecutively along an inner peripheral surface of the sealing member.

5. The dishwasher according to claim 1, wherein a sleeve coupling to the sump is formed under the tub, and the sealing member is bent in an “L” shape and closely attached on an outer peripheral surface of the sleeve while enclosing the sleeve.

6. The dishwasher according to claim 5, further comprising a lower protrusion formed on a lower side of the sealing member and contacting a bottom of the sleeve.

7. The dishwasher according to claim 1, further comprising at least one protrusion protruding from an outer peripheral surface of the sealing member and closely attached on an inner peripheral surface of the sump at an edge.

8. The dishwasher according to claim 1, wherein an upper end of the sealing member extends more than an upper edge of the sump.

9. A dishwasher comprising:
a sump;
a tub including a sleeve extending downward from a bottom of the tub to couple to an inner peripheral surface of the sump; and
a sealing member including a plurality of protrusions contacting an inner peripheral surface of the sump and an outer peripheral surface of the sleeve to prevent a washing water leakage.

10. The dishwasher according to claim 9, wherein the protrusions are banded to correspond to the inner peripheral surface of the sump and the outer peripheral surface of the sleeve.

11. The dishwasher according to claim 9, wherein the protrusion comprises:
an outer protrusion formed on an outer peripheral surface of the sealing member; and
an inner protrusion formed on an inner peripheral surface of the sealing member.

12. The dishwasher according to claim 9, wherein the sealing member is bent in an “L” shape to enclose the sleeve.

13. The dishwasher according to claim 9, wherein a plurality of lower protrusions contacting a lower surface of the sleeve are formed on a lower side of the sealing member.

14. The dishwasher according to claim 9, wherein an upper end of the sealing member extends more than an upper edge of the sump.
